(19) United States
(12) Patent Application Publication
(10) Pub. No.: US 2012/0057132 A1
(43) Pub. Date: Mar. 8, 2012

(54) DEVICE FOR PROJECTING IMAGES

(76) Inventors: Hans Röder, Berlin (DE); René de la Barré, Mittweida (DE)

(21) Appl. No.: 13/320,574

(22) PCT Filed: Mar. 3, 2010
(86) PCT No.: PCT/EP2010/001597

§ 371 Date: Nov. 15, 2011

(30) Foreign Application Priority Data
May 15, 2009 (DE) 10 2009 022 020.8

(51) Int. Cl. G02B 27/22; G03B 21/14; G03B 21/60; G03B 21/56

(52) U.S. Cl. 353/7; 359/443; 353/30; 359/455; 359/451

(57) ABSTRACT

The invention relates to a device for projecting images, comprising an optical element serving as projection surface and at least one projector (1, 1′) at a spacing from the projection surface by a projection spacing (S₁) for projecting respectively an image onto the projection surface, the optical element being designed such that light emanating from the projector (1, 1′) is directed into a spatially delimited viewing zone (6, 6′) which is consequently assigned unequivocally to this projector (1, 1′), a viewing zone (6, 6′) being defined as the region from which the image projected by the projector (1, 1′) to which this viewing zone (6, 6′) is assigned is completely visible, and a viewing plane being definable as a plane which is at a spacing from the projection surface by a viewing spacing (S₂) and in which a width of the viewing zone (6, 6′) is maximum. The optical element is structured such that light emanating from the projector (1, 1′) illuminates in the viewing plane at least one continuous surface which has, in every direction, a diameter which is greater than a diameter of an exit pupil of the projector (1, 1′) multiplied by the viewing spacing (S₂) divided by the projection spacing (S₁).

The invention relates to a device for projecting images, having an optical element serving as projection surface and at least one projector which is disposed at a spacing from the projection surface by a projection spacing for projecting respectively an image onto the projection surface according to the preamble of the main claim.

In the case of generic devices, the optical element is designed such that light emanating from the at least one projector is directed into a spatially delimited viewing zone which is consequently assigned unequivocally to this projector, the viewing zone being defined as the region from which the image projected by the projector to which this viewing zone is assigned is completely visible, and a viewing plane being definable as a plane which is at a spacing from the projection surface by a viewing spacing and in which a width of the viewing zone is maximum. Here and subsequently, the viewing spacing thereby describes a spacing relative to a reference point situated typically in the centre on the projection surface or relative to a reference plane which is defined by the projection surface at the reference point, whilst the viewing plane is orientated orthogonally to this spacing.

Such devices known from the state of the art differ from conventional projection devices which have a diffusion screen provided for example by a screen and a projector having an imaging element and a lens for imaging this imaging element onto the diffusion screen. In the case of these conventional projection devices, exclusive perceptibility of the projected image in one spatially delimited region cannot be achieved.

Generic devices from the state of the art have in contrast an optical element as projection surface which is provided for example by a spherical mirror or a Fresnel lens. This optical element then forms an exit pupil of the projector, the exit pupil being situated at a spacing, termed in the present case projection spacing, from this spherical mirror. In a specific region around the image of this exit pupil which is termed viewing zone, the image displayed by the projector can be completely perceived, whilst it is not at all or only partially visible outwith this region—delimited laterally by an edge of the image of the exit pupil. As a result, generic devices are suitable for example for displaying different images for different viewers (known as “private view” application) or for displaying stereoscopic half-images with two or more projectors so that the half-images are visible in respectively one of a corresponding number of laterally offset viewing zones and can be perceived autostereoscopically by a viewer. Furthermore, diffusion losses are avoided and an exceptionally good light yield is achieved, which makes use of comparatively low-power projectors possible.

In the case of such devices, a size of the viewing zone is produced unequivocally from imaging properties of the optical element serving as projection surface and a size of the exit pupil of the projector so that the viewing zones have a diameter of the same order of magnitude as the exit pupils.

A disadvantage of such devices can be seen in the consequently very restricted size of the viewing zones, which makes use of disadvantageously large and expensive projectors with large exit pupils necessary. In fact, the viewing zones cannot be of an arbitrary small size if the projected images are intended to be visible in a reasonably comfortable manner and a viewer is also intended to be able to move at least within certain limits without “losing” the images.

The object therefore underlying the invention is to propose a corresponding device which, even when using commercially available or particularly compact projectors with small exit pupils, enables comfortable viewing of the projected images, the device being intended at the same time to be suitable for using low-power projectors.

This object is achieved according to the invention by a device having the characterising features of the main claim in conjunction with the features of the preamble of the main claim. Advantageous embodiments and developments of the invention are produced with the features of the dependent claims.

In the device according to the invention, the optical element is structured such that light emanating from the projector illuminates in the viewing plane at least one continuous surface which has, in every direction, a diameter which is greater than a diameter, measured in the same direction, of an exit pupil of the projector multiplied by the viewing spacing divided by the projection spacing. The viewing plane, viewing spacing and projection spacing may again be defined as above, the mentioned continuous surface being produced as interface comprising viewing zone and viewing plane. In the viewing plane, not only the width of the viewing zone is thereby maximum but, at the same time, a surface illuminated entirely by the projector is minimal.

As a result of the fact that the optical element serving as projection surface is structured as proposed, the viewing zone is enlarged as projection surface relative to a comparable arrangement with a conventional imaging element, such as e.g. a spherical mirror, as a result of which a user enjoys increased freedom of movement when viewing the image. Advantageously, the viewing zone is nevertheless still spatially restricted, namely at least in the lateral direction. As a result, the device is suitable, despite the extension of the viewing zones, for the application described above as “private view” or for displaying a plurality of stereoscopic half-images which are visible from different adjacent zones for respectively one of two eyes of a viewer. Furthermore, a spatial restriction of the viewing zones—even in an embodiment with only one projector—has the advantage that even fairly slow projectors can be used. Light emanating from the respective projector is in fact distributed not, as when using a diffusion screen, onto an entire half-space, but is directed into the spatially restricted viewing zone. Thus the various advantages of known devices are combined with projection surfaces produced by spherical mirrors or Fresnel lenses, on the one hand, and with projection surfaces produced by diffusion screens, on the other hand, the respective disadvantages being avoided extensively.

There is intended with the spatially delimited viewing zone in the present case a viewing zone of course which, because of the properties of the optical element serving as projection surface and a beam path forced through it, is delimited at least in width and depth. What is not intended is a spatial delimitation provided by external obstacles, such as would be produced for example by walls of a building surrounding the device.

The advantages of the proposed device are shown to advantage in particular when it has at least two adjacently disposed projectors for projecting respectively one of a plurality of images onto the optical element, the viewing zones assigned to these projectors being mutually offset laterally. The data provided above relating to the size of the viewing zone with reference to the exit pupil of the projector to which this viewing zone is assigned apply then respectively for each of the projectors. As a function of positioning of the projectors and the position resulting therefrom of the viewing zones assigned to these projectors, either different monoscopic images can thus be displayed for a plurality of viewers or stereoscopic half-images which can be combined to form stereoimages for one or more viewers. It must hereby be mentioned that each projector produces at least one viewing zone. It is however possible that viewing zones which are produced by different projectors overlap. This can be advantageous with arrangements for displaying stereoscopic images. Overlapping of this type which leads to cross-talk of different images is desired for example in arrangements with which more than two stereoscopic half-images are intended to be provided for one or more users. A so-called “multiview” operation is consequently possible, in which the user can see different views autostereoscopically dependent upon his exact position. As a result, an impression of spatial viewing can be intensified.

In the case of particularly advantageous embodiments of the proposed device, the projectors are accordingly designed to project the images in the form of stereoscopic half-images, the viewing zones of all or at least two of the projectors assuming their maximum width at the same viewing spacing from the optical element so that an image composed of the half-images or respectively two of the half-images can be perceived autostereoscopically and three-dimensionally from these viewing zones.

Autostereoscopic viewing is then possible in a particularly good manner if the respectively adjacent viewing zones which overlap preferably in the observed areas—in the preferably common viewing plane—are offset laterally relative to each other by between 45 mm and 70 mm. This makes it possible for a viewer to position himself such that his two eyes are situated in two different viewing zones. If more than two stereoscopic half-images are provided in order to effect amplification of the spatial impression by means of a position-dependent viewability of different views, then it is sensible to choose the spacing between adjacent viewing zones to be less than 65 mm in order to avoid the two eyes of the viewer being able to be situated in a single viewing zone.

In particular in embodiments in which only two stereoscopic half-images are projected, it can be advantageous if the at least one projector is moveable in order to track the viewing zone assigned to this projector. As a result, a movement of the viewer can be compensated for. Automatic tracking can thereby be achieved if the device has a system for detecting the movement of the viewer, which system is designed to control a movement of the at least one projector as a function of the detected movement of the viewer. For displaying stereoscopic images comprising two half-images, it is also conceivable to design such a system such that it can adapt at the same time the spacing from adjacent viewing zones to the eye spacing of users.

According to the embodiment, the optical element serving as projection surface, on which the image projected by the at least one projector is intended to be focused, can be a structured hollow mirror or a structured lens, the at least one projector, in the just mentioned case, being situated on a side, orientated away from the viewer, of the (transmitting) projection surface and in the first case on the same side of the (reflecting) projection surface as the viewer. The required properties of the optical element can thereby be produced particularly well if the optical element is configured as a structured Fresnel lens or as a structured spherical mirror. As an alternative, also for example a correspondingly structured flat Fresnel mirror, a Fresnel cylindrical mirror or an elliptical mirror can be used as optical element on which the images are projected. Fresnel mirrors can thereby comprise differential mirror elements, the surface normals of which are all orientated towards a hypothetical centre.

The optical element should not scatter diffusely at least in the lateral direction in order that a lateral delimitation of the at last one viewing zone and hence a separation of the viewing zones of a plurality of projectors is possible.

An advantageous production of a structuring of the optical element provides that the optical element is divided into a large number of separate partial surfaces, each of the partial surfaces being formed such that light emanating from the exit pupil of the projector or of each of the projectors and impinging on the partial surface, in the case of illumination of this partial surface in the viewing plane, illuminates respectively one surface which has a greater diameter than the exit pupil of the projector multiplied by the viewing spacing divided by the projection spacing. It is herewith intended that light produced by the projector which illuminates completely any one of the separate partial surfaces is directed such that it fills the entire viewing zone.

It is possible for example that the image projected by a projector is subdivided into a large number of pixels, each pixel illuminating at least one or more of the separate partial surfaces. With the light illuminating each of these partial surfaces, in particular the light emanating from each of the pixels can then be perceived in the complete viewing zone.

In the case of a small difference between a size of the separate partial surface and a size of the pixels of the image projected onto the optical element, disruptive moiré patterns can occur in unfavourable cases. It can therefore be advantageous to choose the partial surfaces to be so small that one pixel covers a plurality of partial surfaces. The use of sufficiently small partial surfaces is also desirable for the reason that it would be disruptive for a user of the device if he could make out the structure of the optical element when viewing the image.

Generally, it will suffice if it is ensured that, from the viewing zones, the viewing angle covered by one of the separate partial surfaces is less than 4′ since this corresponds to a typical resolution capacity of the human eye during relaxed viewing of images. It is even better if this viewing angle is not greater than 2′ or 1′ in order to preclude detectability of the structuring also during concentrated viewing. The appropriate choice of the mentioned viewing angle is advantageous since too coarse structuring disturbs the user whilst too fine structuring increases the production costs unnecessarily. The partial surfaces can thereby have, for example at least in the lateral direction, respectively a diameter of at most 1.5×10⁻³ times the viewing spacing. Typically, this will also apply to a vertical extension of the partial surfaces, which is however not absolutely necessary if the optical element—and, with it, each of the individual partial surfaces—has a structure scattering in the vertical direction. The latter is not detrimental because separation of viewing zones in the lateral direction is sufficient to achieve the mentioned advantages.

The separate partial surfaces can have a square or rectangular edge, which entails a particularly simple structure of the optical element, or be for example hexagonal, with which moiré patterns can be avoided particularly well because imaging elements of the projectors typically have pixels distributed in a matrix shape.

The separate partial surfaces can be achieved in very different ways and for example be formed by microlenses or micromirrors. The mentioned partial surfaces can be formed in particular by bulges or depressions on a surface of the optical element. The desired properties of the optical element can thereby be produced particularly easily in that the partial surfaces are configured to form respectively a spherical section-shaped surface (i.e. formed as part of a spherical surface) or toroidal surface. By using toroidal partial surfaces, it is possible to produce viewing zones which are suitable for separate perception of two stereoscopic half-images by two eyes of a user in that they are sufficiently narrow for lateral separation, whilst at the same time they do not unnecessarily restrict the movement of a user in the vertical direction.

If it suffices, that the viewing zones are delimited sharply laterally, that the partial surfaces can also be formed by vertical cylinder casing-shaped (of course a section of a cylinder casing is intended) or toroidal strips which extend over the entire optical element and can be provided with a surface structure which scatters in the vertical direction. The vertically scattering surface structure can be provided by grooving in the horizontal direction.

Also mixed use of cylindrical or toroidal micromirrors and microlenses in a catadioptric system is conceivable. For example, in this case the optical element can have a family of cylinder casing-shaped or toroidal strips which extend vertically over the optical element, the partial surfaces then being provided by respectively one overlapping region of one of the vertically extending strips with one of the horizontally extending strips.

Typically, the at least one projector will have at least one imaging element—e.g. an LCD or a micromirror array—and a lens imaging the imaging element onto the optical element. However, projectors, in the case of which the projection surface is scanned with an individual thin light bundle—for example by rapid pivoting of a micromirror, are also conceivable. In this case, the exit pupil may be defined by the diameter of the light bundle on a light outlet surface of the projector. In every case, the proposed device then develops its advantages in a particular way if the at least one projector is provided by a compact projector to be termed microprojector which has at least one LED—possibly also at least one laser diode—for producing light required for projecting the respective image. Then the projector typically has such a small exit pupil that the device can be used sensibly only by the proposed extension of the viewing zones, whilst at the same time very limited power of the projector is not detrimental because of the still achieved bundling of light emanating from the projection surface.

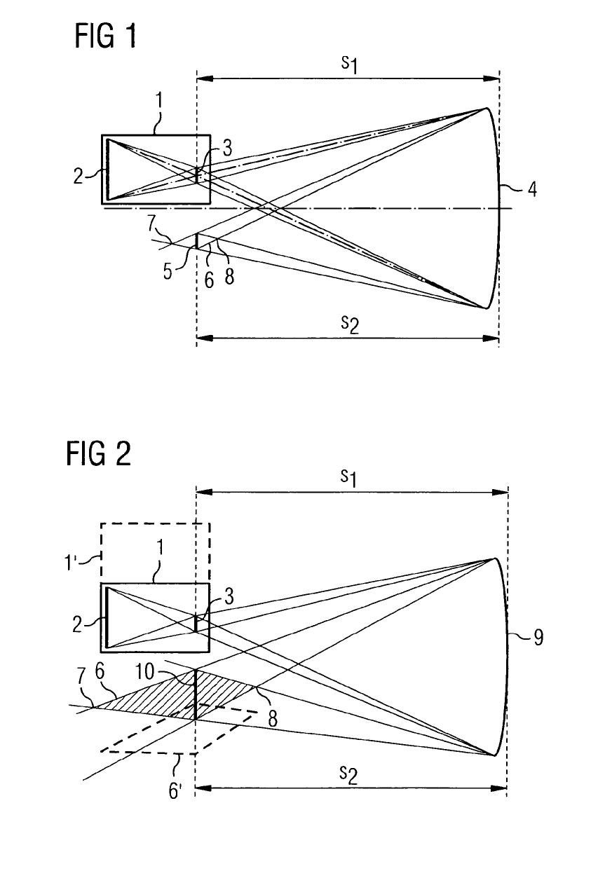

Embodiments of the invention are explained subsequently with reference to FIGS. 1 to 5. There are shown

FIG. 1 a representation of the state of the art which is helpful in understanding the invention,

FIG. 2 an advantageous embodiment of a device according to the invention as a schematically represented view,

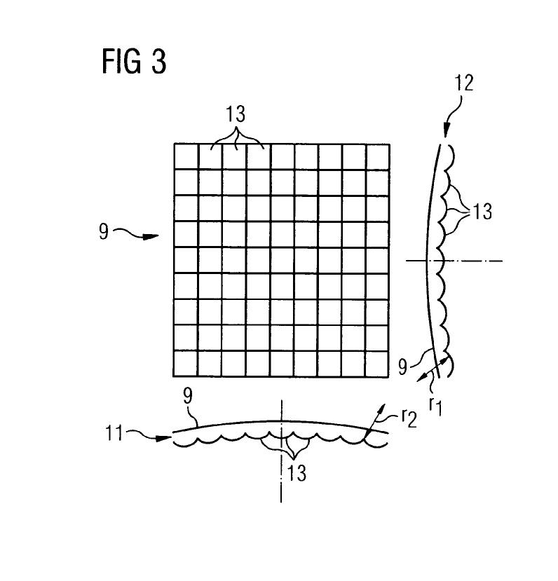

FIG. 3 a section of an optical element serving as projection surface of the device of FIG. 2,

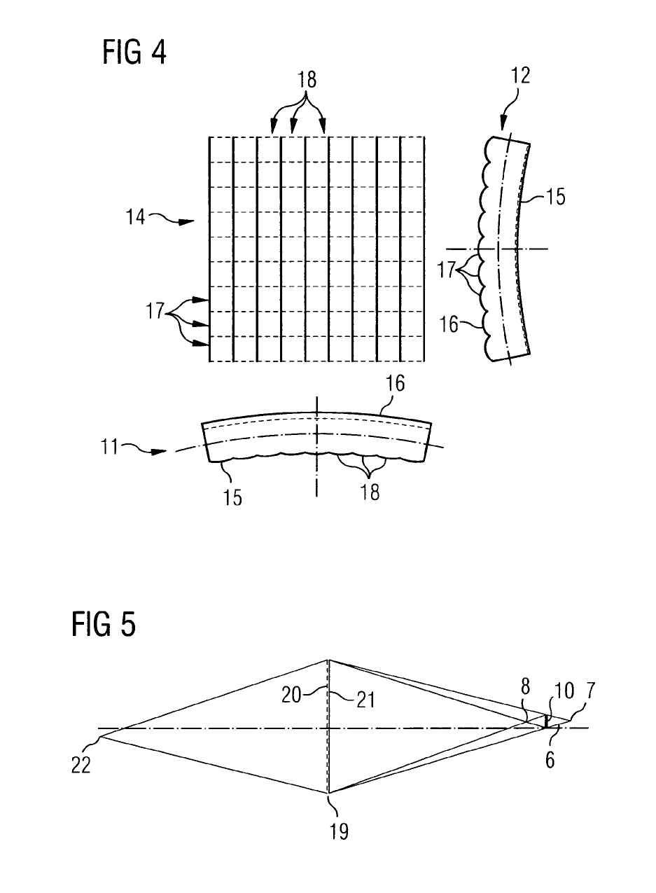

FIG. 4 in a corresponding representation, a section of an optical element which serves as projection surface in a modification of the device of FIG. 2, and

FIG. 5 a schematic view on an optical element serving as projection surface in another embodiment of the invention.

In FIG. 1, a device for projecting images, known from the state of the art, is shown. A projector 1 has an imaging element 2 and also a lens 3. An image displayed by the imaging element 2 is imaged by the lens 3 onto a spherical mirror 4 serving as projection surface. This spherical mirror 4 forms an exit pupil of the lens 3 on a pupil image 5. The image displayed by the imaging element 2 can be seen completely in one viewing zone 6. The viewing zone 6 is precisely the spatial area which is situated within the two cones which have the pupil image 5 as base and the tips of which are defined by the beam intersection points 7 and 8 which can be detected in FIG. 1. This viewing zone 6 is disadvantageously small and allows a viewer situated at the position of the pupil image 5 almost no freedom of movement unless a projector which has an exceptionally large exit pupil is used. In the chosen geometry in which a viewing spacing s₁—defined as spacing between exit pupil of the projector 1 and projection surface—and a viewing spacing s₂—defined as spacing between projection surface and a viewing plane defined here by the pupil image 5—is equally large, namely also a diameter of the viewing zone 6, defined by the pupil image 5, is just as large as the exit pupil. In a construction of the type shown in FIG. 1, it applies in general that the diameter of the viewing zone 6 corresponds to the diameter of the exit pupil multiplied by s₂ divided by s₁.

In FIG. 2, an embodiment of a device according to the invention is shown, recurring features and sizes being provided again with the same reference numbers. The difference from the device shown in FIG. 1 resides in the fact that, instead of the spherical mirror 4, a structured spherical mirror 9 is used as optical element forming the projection surface. A structure of a surface of this spherical mirror 9, added to the spherical surface shape, ensures that light reflected by the spherical mirror 9 illuminates a significantly larger solid angle than is the case when using the normal spherical mirror 4, as shown in FIG. 1. Both cones or deformed cones which form the viewing zone 6 (illustrated hatched in this Figure) have here a base 10 defining the viewing plane which is significantly larger than the surface of the pupil image 5 which forms the base of the two cones when using the normal spherical mirror 4. Furthermore, because of the radiation in a larger solid angle, the two beam intersection points 7 and 8 forming the tips of the cone are situated here significantly further away from the base 10 than is the case with a corresponding conventional device of the type shown in FIG. 1. In particular, it applies that a diameter of the base 10 measured in any direction is greater than a diameter of the exit pupil, measured in the same direction, multiplied by s₂ divided by s₁.

In addition, a further projector 1′ is represented in FIG. 2 merely in broken lines, which projector is disposed offset laterally relative to the first projector 1 and to which a second viewing zone 6′ which is produced entirely analogously is assigned. The two viewing zones 6 and 6′ are mutually offset correspondingly laterally by approx. 65 mm and overlap only in a small edge region. The projectors 1 and 1′, which concern very compact microprojectors with LEDs or laser diodes as light sources, are suitable for reproducing stereoscopic half-images which are combined together to form 3D images. The 3D images can be perceived autostereoscopically consequently by a viewer who is positioned such that respectively one of his eyes is situated in each of the two viewing zones 6 and 6′. The projectors 1 and 1′ can thereby be configured to be moveable by means of a tracking device, not shown, so that the viewing zones 6 and 6′ can be tracked as a function of a movement of the viewer which is detected for this purpose. Instead of the two projectors 1 and 1′, also a larger number of projectors can be disposed adjacently in order to produce a correspondingly larger number of viewing zones from which respectively one of a plurality of views can be seen.

FIG. 3 shows an example of how the structure of the structured spherical mirror 9 can be configured. In addition to a front view of a part of a reflective surface of the spherical mirror 9, also a horizontal cross-section 11 and a vertical cross-section 12 through this part of the structured spherical mirror 9 is shown there. In both cross-sections 11 and 12, a knob structure can thereby be detected, having a large number of knobs 13 which respectively have a square outline which can be detected in the front view and together form the reflective surface. In the present embodiment in which the viewing spacing s₂ is 100 cm, each of these knobs 13 has a lateral length of approx. 0.29 mm. The structured spherical mirror 9, which has in this case—apart from the knob structure—a radius of 1 m corresponding to s₁ and s₂, has therefore an essentially larger number of these knobs 13 than can be detected in FIG. 3. The spherical mirror 9 can have for example as many knobs 13 as the imaging element 2 has of image points or pixels, or even significantly more.

In the present case, the knobs 13 form convex micromirrors, instead of which however also concave depressions can be provided in the reflective surface. It is also possible to choose other contour shapes of the knobs 13 which are intended to fill the reflective surface of the spherical mirror 9 as completely as possible over the surface, for example in the form of hexagons disposed in a honeycomb shape.

Each of the knobs 13 form a partial surface of the reflective surface of the spherical mirror 9 which, for its part, has the property that light emanating from the exit pupil of the projector 1 or 1′ and illuminating this partial surface fills the viewing zone 6 or 6′ completely after a reflection on this partial surface. For this purpose, the knobs 13 have a toroidal surface, a curvature of this surface in the vertical direction being defined by a radius of curvature r₁ and a curvature in the horizontal direction by a radius of curvature r₂. The two radii r₁ and r₂ can thereby be calculated to a good approximation as follows:

r¹=h[2(R²+4H²+R[R²+4H²]^{1/2})]^{1/2}/(H−2h),

r²=b[2(R²+4B²+R[R²+4B²]^{1/2})]^{1/2}/(B−2b),

R thereby describes the radius of curvature of the spherical mirror 9 which is identical to the viewing spacing s₂ (when neglecting the knob structure), h describes a height and b a width of the individual partial surfaces or knobs 13 (there applying here h=b) and also H describes the height and B the width of the viewing zone 6 or 6′. B can thereby be chosen as approx. B=65 mm, whilst H can be significantly greater.

FIG. 4 shows a further possibility for producing a structured optical element 14 according to the invention, which can be used as projection surface in a device of the type shown in FIG. 2. Again, in addition to a front view, also a horizontal cross-section 11 and a vertical cross-section 12 is shown. A front-side interface 15 of the optical element 14 replacing the spherical mirror 9 is configured such that as far as possible it does not reflect. A rear-side surface 16 is metallised in contrast. The surface 16 has horizontally extending toroidal annular surfaces, whilst the front-side surface 15 has vertically extending toroidal annular surfaces 18. The toroidal annular surfaces 17 and 18 span the optical element as thin strips which form respectively, wherever they intersect, a partial surface which corresponds extensively respectively to one of the knobs 13 from the previous embodiment. As a result, the same effect in total is produced as by the structure shown in FIG. 3. In comparison with the latter, the easier production should be advantageous. As a result, slight imaging errors can be produced. The optical element of FIG. 4 which forms a catadioptric system can be produced for example in that a grid plate with vertical cylinder lenses on a front-side and horizontal cylinder lenses on a rear-side is reshaped to form a spherical shell so that the front-side becomes concave. The rear-side can subsequently be metallised. It would also be possible to provide, instead of the horizontal cylinder lenses or toroidal annular surfaces, a horizontal grooving which endows the optical element in the vertical direction—and only in the vertical direction—with diffusely scattering properties.

FIG. 5 shows an arrangement which has an optical element 19 to be operated in transmission. In this embodiment, the optical element 19 serving as projection surface comprises a microstructure plate 20 and a Fresnel lens 21. In this example, a microprojector is used for projecting images onto the optical element 19, only an exit pupil 22 thereof being illustrated here. This is so small that without the microstructure plate 20 a virtually punctiform viewing zone would be produced. By using the microstructure plate 20 which can be formed similarly to the previously mentioned grid plate, a sufficiently large viewing zone 6 with the base 10 and the beam intersection points 7 and 8 is provided. Of course, a plurality of projectors can also be disposed here adjacently in order to direct various images or stereoscopic half-images into adjacent viewing zones.

1. Device for projecting images, comprising an optical element (14; 19) serving as projection surface and at least one projector (1, 1′) at a spacing from the projection surface by a projection spacing (s₁) for projecting respectively an image onto the projection surface, the optical element (14; 19) being designed such that light emanating from the projector (1, 1′) is directed into a spatially delimited viewing zone (6, 6′) which is consequently assigned unequivocally to this projector (1, 1′), the viewing zone (6, 6′) being defined as the region from which the image projected by the projector (1, 1′) to which this viewing zone (6, 6′) is assigned is completely visible, and a viewing plane being definable as a plane which is at a spacing from the projection surface by a viewing spacing (s₂) and in which a width of the viewing zone (6, 6′) is maximum,
characterized in that
the optical element (14; 19) is structured such that light emanating from the projector (1, 1′) illuminates in the viewing plane at least one continuous surface which has, in every direction, a diameter which is greater than a diameter, measured in the same direction, of an exit pupil (22) of the projector (1, 1′) multiplied by the viewing spacing (s₂) divided by the projection spacing (s₁).

2. Device according to claim 1, characterized in that it has at least two adjacently disposed projectors (1, 1′) for projecting respectively one of a plurality of images onto the optical element (14; 19), the viewing zones (6, 6′) assigned to these projectors (1, 1′) being mutually offset laterally.

3. Device according to claim 2, characterized in that the projectors (1, 1′) are designed to project the images in the form of stereoscopic half-images, the viewing zones (6, 6′) of all or at least two of the projectors (1, 1′) assuming their maximum width at the same viewing spacing (s₂) from the optical element (14; 19) so that an image composed of the half-images or respectively two of the half-images can be perceived autostereoscopically and three-dimensionally from these viewing zones (6, 6′).

4. Device according to claim 3, characterized in that the respectively adjacent viewing zones (6, 6′) which overlap preferably in the edge areas are offset laterally relative to each other by between 45 mm and 70 mm.

5. Device according to claim 1, characterized in that the optical element (14; 19) is a structured hollow mirror or a structured lens.

6. Device according to claim 1, characterized in that the optical element (14; 19) is configured as a structured Fresnel lens or as a structured spherical mirror (9).

7. Device according to claim 1, characterized in that the optical element (14; 19) does not scatter diffusely at least in the lateral direction.

8. Device according to claim 1, characterized in that the optical element (14; 19) is divided into a large number of separate partial surfaces, each of the partial surfaces being formed such that light emanating from the exit pupil (22) of the projector (1, 1′) or each of the projectors (1, 1′) and impinging on the partial surface, in the case of illumination of this partial surface in the viewing plane, illuminates respectively one surface which has a greater diameter than the exit pupil (22) of the projector (1, 1′) multiplied by the viewing spacing (s₂) divided by the projection spacing (s₁).

9. Device according to claim 8, characterized in that the partial surfaces have, at least in the lateral direction, respectively a diameter of at most 1.5×10⁻³ times the viewing spacing (s₂).

10. Device according to claim 8, characterized in that the separate partial surfaces have a square, rectangular or hexagonal edge.

11. Device according to claim 8, characterized in that the separate partial surfaces are formed by microlenses or micromirrors.

12. Device according to claim 8, characterized in that the mentioned partial surfaces are formed by bulges or depressions on a surface of the optical element (14; 19).

13. Device according to claim 8, characterized in that the partial surfaces form respectively a spherical section-shaped or toroidal surface.

14. Device according to claim 8, characterized in that the partial surfaces are formed by vertical cylinder casing-shaped or toroidal strips extending over the entire optical element.

15. Device according to claim 14, characterized in that the mentioned strips are provided with a surface structure which scatters in the vertical direction.

16. Device according to claim 8, characterized in that the optical element (14; 19) has a family of cylinder casing-shaped or toroidal strips which extend vertically over the optical element and a family of cylinder casing-shaped or toroidal strips extending vertically over the optical element (14; 19), the partial surfaces being provided by respectively one overlapping region of one of the vertically extending strips with one of the horizontally extending strips.

17. Device according to claim 1, characterized in that the at least one projector (1, 1′) is moveable in order to track the viewing zone (6, 6′) assigned to this projector (1, 1′), in order to compensate for a movement of a viewer.

18. Device according to claim 17, characterized in that it has a system for detecting the movement of the viewer and for controlling a movement of the at least one projector (1, 1′) as a function of the detected movement of the viewer.

19. Device according to claim 1, characterized in that the at least one projector (1, 1′) has at least one imaging element (2) and a lens (3) imaging the imaging element onto the optical element (14; 19).

20. Device according to claim 1, characterized in that the at least one projector (1, 1′) is provided by a microprojector which has at least one LED or laser diode for producing light required for projecting the respective image.
